(19) United States
(12) Patent Application Publication
(10) Pub. No.: US 2025/0180059 A1
(43) Pub. Date: Jun. 5, 2025

(54) METHOD FOR SECURING NUTS IN A HIGH VIBRATING ENVIRONMENT

(71) Applicant: Air Liquide Large Industries U.S. LP, Houston, TX (US)

(72) Inventor: Gary D. MILLER, Houston, TX (US)

(21) Appl. No.: 18/529,874

(22) Filed: Dec. 5, 2023

(51) Int. Cl. F16B 39/10

(52) U.S. Cl. CPC F16B 39/101

(57) ABSTRACT

An apparatus for securing nuts in a vibrating environment, including a plurality of anti-vibration adaptors, designed to mate with a nut in a vibrating environment, and a plurality of anti-vibration rods. Wherein at least two adjacent anti-vibration adaptors are rigidly linked by an anti-vibration rod, thereby forming an anti-vibration web. A method for securing nuts in a vibrating environment, including attaching an anti-vibration adaptor to each of a plurality of nuts in a vibrating environment, and rigidly linking each anti-vibration adaptor to at least two adjacent anti-vibration adaptors, thereby forming an anti-vibration web. Thus, allowing each anti-vibration adaptor to be associated with a specific nut, and prohibiting any anti-vibration adaptor and the associated nut to turn.

### BACKGROUND

Bolts are one of the most common fasteners. They are typically used to secure material or components together. The bolt is often used in combination with a nut, to form a secure, bolted connection. Given their utility and versatility, and being easy to install, adjust or remove, they are used throughout the industry.

However, as they are not designed nor intended to be permanent, they may to experience loosening over time. Once particular source of such unwanted loosening is from vibrations. There is a need in the industry for an apparatus and method for preventing nuts from loosening due to vibration.

### SUMMARY

An apparatus for securing nuts in a vibrating environment, including a plurality of anti-vibration adaptors, designed to mate with a nut in a vibrating environment, and a plurality of anti-vibration rods. Wherein at least two adjacent anti-vibration adaptors are rigidly linked by an anti-vibration rod, thereby forming an anti-vibration web.

A method for securing nuts in a vibrating environment, including attaching an anti-vibration adaptor to each of a plurality of nuts in a vibrating environment, and rigidly linking each anti-vibration adaptor to at least two adjacent anti-vibration adaptors, thereby forming an anti-vibration web. Thus allowing each anti-vibration adaptor to be associated with a specific nut, and prohibiting any anti-vibration adaptor and the associated nut to turn.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1a is a schematic representation of a top view of an anti-vibration adaptor, in accordance with one embodiment of the present invention.

FIG. 1b is another schematic representation of a top view of an anti-vibration adaptor, in accordance with one embodiment of the present invention.

FIG. 1c is another schematic representation of a cutaway side view of an anti-vibration adaptor, in accordance with one embodiment of the present invention.

FIG. 2 is a schematic representation of a top view of fastening bolts to be secured, in accordance with one embodiment of the present invention.

FIG. 3 is a schematic representation of a top view of the fastening bolts with anti-vibration adaptors partially installed, in accordance with one embodiment of the present invention.

FIG. 4a is a schematic representation of a top view of the fastening bolts with anti-vibration adaptors fully installed, in accordance with one embodiment of the present invention.

FIG. 4b is a schematic representation of a side view of the fastening bolts with anti-vibration adaptors fully installed, in accordance with one embodiment of the present invention.

FIG. 5 is a schematic representation of a side view of the anti-vibration adaptors with connecting rods in place, in accordance with one embodiment of the present invention.

FIG. 6 is a schematic representation of a top view of the anti-vibration adaptors with connecting rods and anti-vibration rods partially installed, in accordance with one embodiment of the present invention.

FIG. 7 is a schematic representation of a top view of the anti-vibration adaptors with connecting rods and anti-vibration rods more fully installed, in accordance with one embodiment of the present invention.

FIG. 8a is a schematic representation of a top view of the anti-vibration adaptors with connecting rods and anti-vibration rods fully installed, in accordance with one embodiment of the present invention.

FIG. 8b is a schematic representation of a side view of the anti-vibration adaptors with connecting rods and anti-vibration rods fully installed, in accordance with one embodiment of the present invention.

FIG. 9a is a schematic representation of a top view of the anti-vibration device installed with a weight in place, accordance with one embodiment of the present invention.

FIG. 9b is a schematic representation of a side view of the anti-vibration device installed with a weight in place, accordance with one embodiment of the present invention.

FIG. 10a is another schematic representation of a top view of the anti-vibration adaptors with connecting rods and anti-vibration rods fully installed, in accordance with one embodiment of the present invention.

FIG. 10b is another schematic representation of a side view of the anti-vibration adaptors with connecting rods and anti-vibration rods fully installed, in accordance with one embodiment of the present invention.

FIG. 11a is another schematic representation of a top view of the anti-vibration device installed with a weight in place, accordance with one embodiment of the present invention.

FIG. 11b is another schematic representation of a side view of the anti-vibration device installed with a weight in place, accordance with one embodiment of the present invention.

FIG. 12 is a schematic representation of a top view of one type of ratcheting mechanism, in accordance with one embodiment of the present invention.

FIG. 13 is another schematic representation of a top view of one type of ratcheting mechanism, in accordance with one embodiment of the present invention.

### ELEMENT NUMBERS

101=anti-vibration adapter
102=bolt receiving end
103=connecting rod receiving end
104=vibrating equipment
105=element being secured
106=fastening nut
107=connecting rod
108=anti-vibration rod
109=weight
110=ratcheting mechanism
111=driven member
112=driver member
113=rollers or balls

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

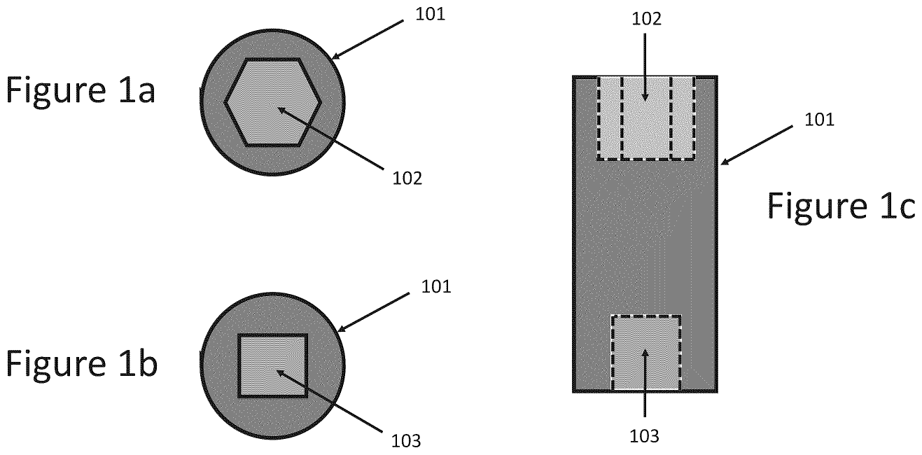

Turning to FIGS. 1a, 1b, 1c, 2, and 3 an anti-vibration device is presented. Anti-vibration adaptor 101 has a bolt receiving end 102 configured to attach securely, but removably, to a fastening nut 106 located on vibrating equipment 104. Anti-vibration adaptor 101 has a connecting rod receiving end 103, configured to attach securely, and permanently, to connecting rod 107. Vibrating equipment 104 may be any type of equipment that is subjected to prolonged or sustained vibrations, possibly also in the presence of an oily or lubricating service, where multiple bolts that must remain tight may periodically become loose. In one illustrative embodiment, vibrating equipment 104 may be an industrial coalescing filter, with filter elements 105 to be secured.

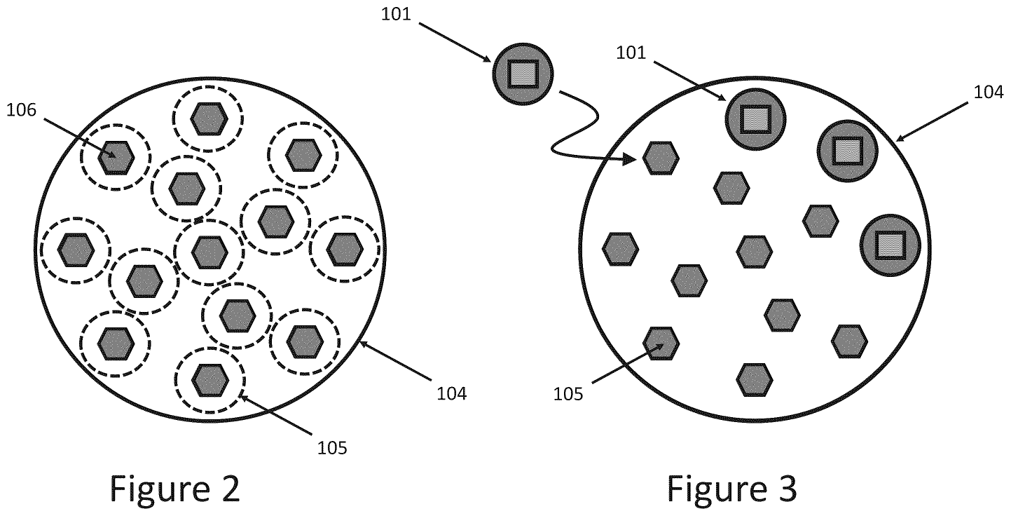

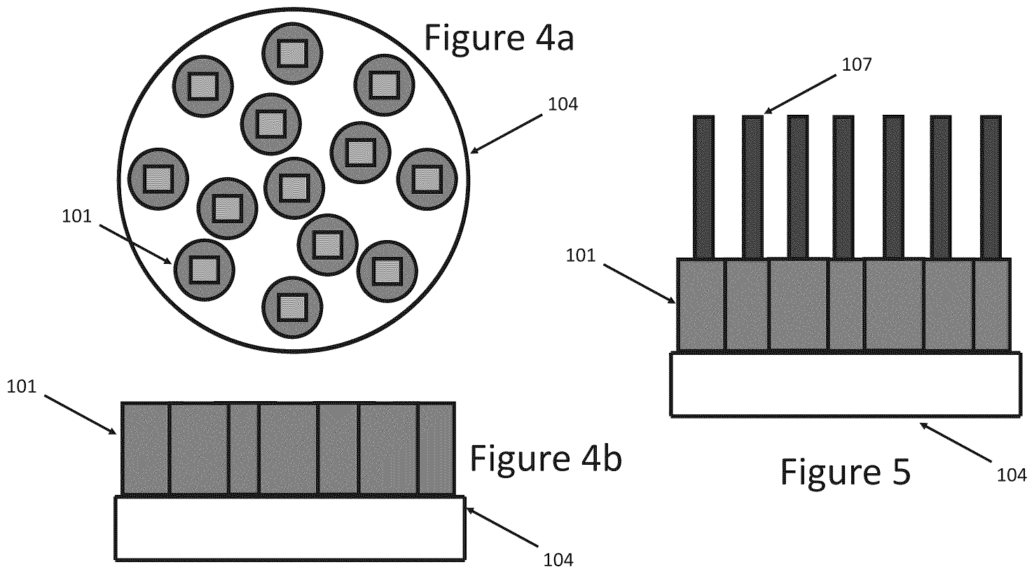

As illustrated in FIGS. 2-11b, vibrating equipment 104 may have numerous fastening bolts 106, which may be in a roughly concentric, circular pattern as illustrated in FIG. 2. The present invention does not require that fastening bolts 106 be in this roughly concentric, circular pattern, but will work in other configurations. Fastening bolts 106 are first tightened to the desired torque. Then anti-vibration adapters 101 are oriented such that bolt receiving end 102 is removably attached to each fastening bolt 106. This is illustrated in FIG. 3, FIG. 4a, and FIG. 4b. Then connecting rods 107 are permanently attached to connecting rod receiving end 103 of each anti-vibration adaptor 101. This is illustrated in FIG. 5, which shows a side view. Connecting rods 107 may be welded or brazed to anti-vibration adaptor. Connecting rods 107 may be permanently attached to anti-vibration adaptor in any fashion known in the art.

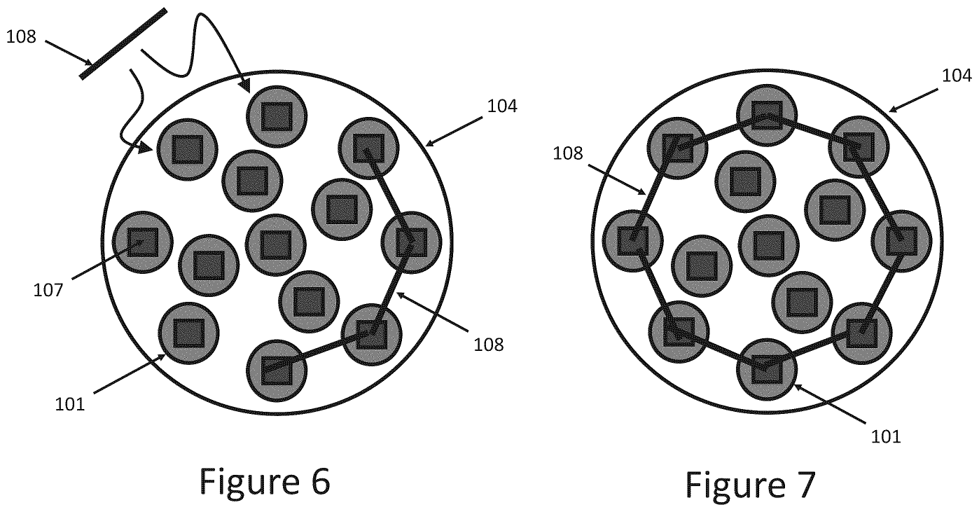

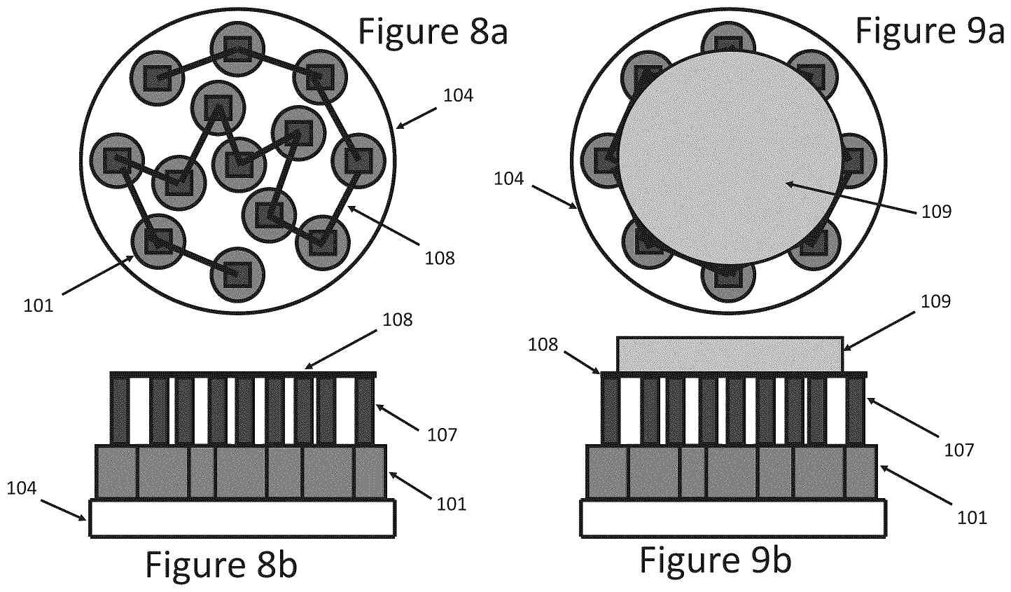

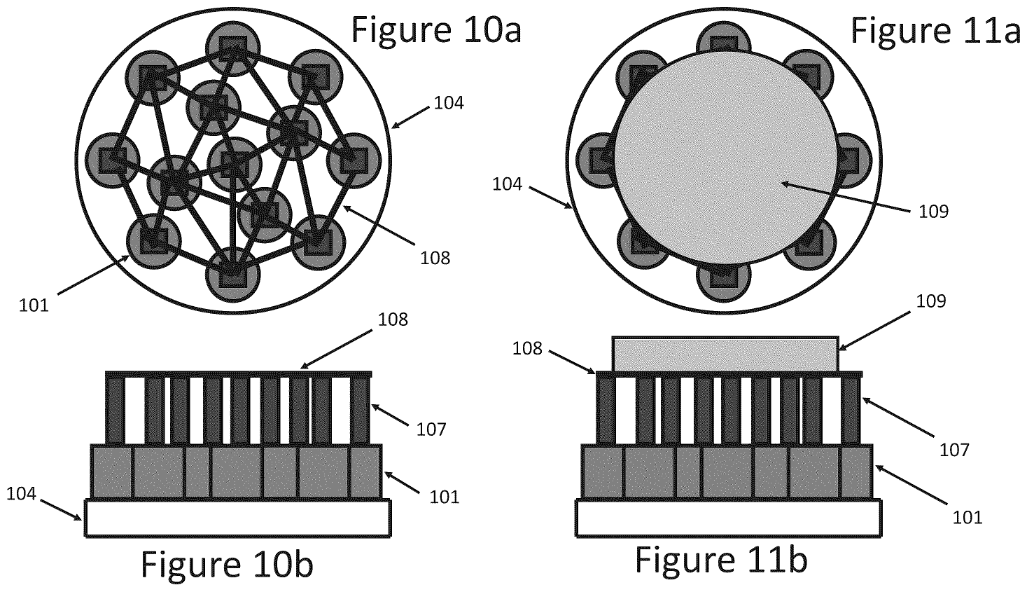

Then anti-vibration rods 108 are permanently attached to each connecting rod 107. This is illustrated in FIG. 6, FIG. 7, FIG. 8a, FIG. 8b, FIG. 10a, and FIG. 10b. In one embodiment, each connecting rod 107 is attached to at least two adjacent connecting rods (as shown in FIG. 8a). In another embodiment each connecting rod 107 is attached to every adjacent connecting rod 107 (as shown in FIG. 10a). Thus, is formed a network or mesh of anti-vibration rods 108, which restricts any single fastening nut 106 from loosening from the vibration. Anti-vibration rods 108 may be welded or brazed to connecting rods 107. Anti-vibration rods 108 may be permanently attached to connecting rods 107 in any fashion known in the art. In one embodiment, after anti-vibration rods 108 are fully attached and all anti-vibration adaptors 101 are securely in place, weight 109 may be introduced on top of the network or mesh of anti-vibration rods 108, in order to keep the anti-vibration system in contact with the fastening nuts 106 during equipment vibration. This is illustrated in FIG. 9a, FIG. 9b, FIG. 11a, and FIG. 11b.

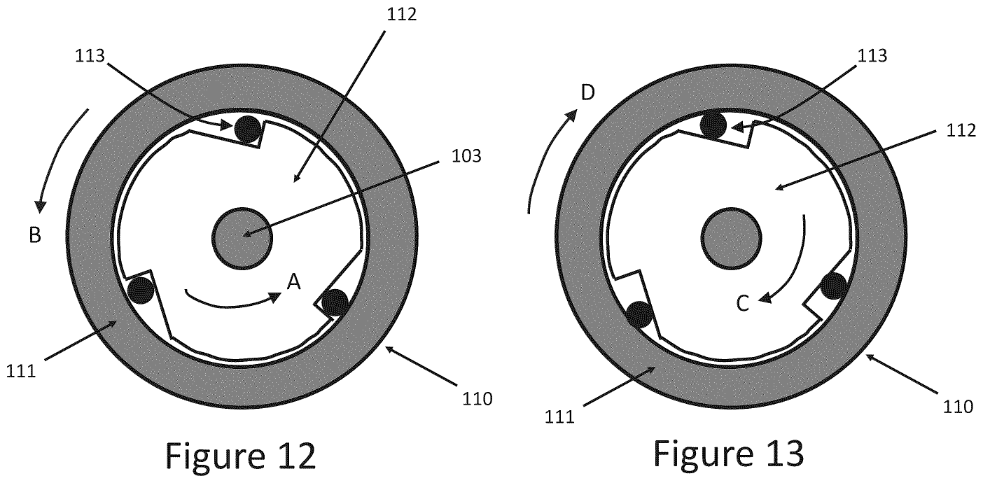

In one embodiment, anti-vibration adaptor 101 may include ratcheting mechanism 110. FIG. 12 and FIG. 13 illustrate one embodiment of such a ratcheting mechanism 110, but any suitable ratcheting mechanism known in the art may be applied. In the non-limiting illustrated example, if driver member 112 rotates counter-clockwise (Direction A), rollers (or balls) 113 will remain free and no torque will be transferred to driven member 111. Thus, driven member 111 will not be moved counter-clockwise (Direction B).

If, however, driver member 112 rotates clockwise (Direction C), rollers (or balls) 113 will become wedged against the inner surface of driven member 111 and against the shoulder of the recess in driver member 112. In this case, torque will be transferred to driven member 111. Thus, driven member 111 will be moved clockwise (Direction D). Such a ratcheting mechanism 110 will allow the fully assembled system to be removed for maintenance and then moved into position to allow each anti-vibration adaptor to once again mate with fastening nuts 106 when maintenance is complete.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for securing nuts in a vibrating environment, comprising:
attaching an anti-vibration adaptor to each of a plurality of nuts in a vibrating environment, and
rigidly linking each anti-vibration adaptor to at least two adjacent anti-vibration adaptors, thereby forming an anti-vibration web,
thereby allowing each anti-vibration adaptor to be associated with a specific nut and thereby prohibiting any anti-vibration adaptor and the associated nut to turn.

2. The method of claim 1, wherein each anti-vibration adaptor comprises a ratcheting mechanism, thereby allowing each anti-vibration adaptor to be positioned to mate with the specific associated nut and thereby allowing the anti-vibration web to be reused.

3. The method of claim 1, further comprising Introducing a weight on top of the anti-vibration web, thereby maintaining firm contact between each anti-vibration adaptor and the associated nut.

4. An apparatus for securing nuts in a vibrating environment, comprising:
a plurality of anti-vibration adaptors, configured to mate with a nut in a vibrating environment,
a plurality of anti-vibration rods,
wherein at least two adjacent anti-vibration adaptors are rigidly linked by an anti-vibration rod, thereby forming an anti-vibration web.

5. The apparatus of claim 4, wherein each anti-vibration adaptor comprises a ratcheting mechanism.

6. The apparatus of claim 4, further comprising a weight configured to be placed on top of the anti-vibration web.
